(19) United States
(12) Patent Application Publication
(10) Pub. No.: US 2005/0097192 A1
(43) Pub. Date: May 5, 2005

(54) Messaging mechanism for retrieving large amounts of configuration data

(75) Inventors: Huimin Li, Shrewsbury, MA (US); Wei Mao, Worcester, MA (US); Craig Boyle, Auburn, MA (US); Peter Dobransky, Leominster, MA (US); Daniel J. Byron, Marlborough, MA (US)

Correspondence Address: FOGG AND ASSOCIATES, LLC, P.O. BOX 581339, MINNEAPOLIS, MN, 55458-1339, US

(73) Assignee: ADC Broadband Access Systems, Inc.

(21) Appl. No.: 10/696,233

(22) Filed: Oct. 29, 2003

(51) Int. Cl. G06F 15/177

(52) U.S. Cl. 709/220

(57) ABSTRACT

A system of retrieving large amounts of configuration data in a communication system. In one embodiment, a method is disclosed that comprises initiating a request for configuration data from a user interface. Sending the configuration request to a data source. Placing the configuration data into a data file in a user interface format at the data source and sending the data file to the user interface.

### TECHNICAL FIELD OF THE INVENTION

The present invention relates generally to configuration data and in particular a system of retrieving large amounts of configuration data.

### BACKGROUND OF THE INVENTION

One method electronic devices use to communicate with each other is with the use of configuration data. Configuration data of an electronic device includes protocols of the device which are used by other devices to establish communications. That is, configuration data of a first device is read and used by other devices to set up communication links between the first device and the other devices. For example, in a telecommunication system including a cable operator and a plurality of cable modems the configuration data of the cable modems can include cable modem cable status, static route, routing information protocol (RIP) and the like. This configuration data is used to establish communication between the cable operator and the plurality of cable modems. This configuration data is critical for the cable operator in monitoring, troubleshooting and managing their subscriber base. Traditionally, simple network management protocol (SNMP) has been used to configure devices (equipment) and retrieve the configuration data using a user interface. SNMP is the most common method by which network management applications can query a device (data source) using a supported management information base. However, a limitation of SNMP is that when the quantity of configuration data is very large, the interface software using the SNMP mechanism can be relatively slow since the format of the data isn't fully optimized for use by the interface software.

For the reasons stated above, and for other reasons stated below that will become apparent to those skilled in the art upon reading and understanding the present specification, there is a need in the art for method of retrieving configuration data from a large number of devices in a fast and efficient manner.

### SUMMARY

The above-mentioned problems and other problems are resolved by the present invention and will be understood by reading and studying the following specification.

In one embodiment, a method of communicating between electronic devices is disclosed. The method comprises initiating a request for configuration data from a user interface. Sending the configuration request to a data source. Placing the configuration data into a data file in a user interface format at the data source and sending the data file to the user interface.

In another embodiment, a method of retrieving a large amount of configuration data in a telecommunication system having one or more command line interfaces, a management module and one or more head-ends is disclosed. The method comprises generating a configuration request from one of the command line interfaces. Receiving the configuration request in an associated local access module. Outputting configuration data in a data file that is in a command line interface friendly format to a management module and passing the data file to the command line interface that requested the configuration data.

In yet another embodiment, a communication system is disclosed. The communication system includes a plurality of command line interfaces, a plurality of local access modules and a management module. The plurality of local access modules are adapted to provide configuration data to select command line interfaces in a command line interface friendly format. The management module is adapted to dispatch interface configuration data between the plurality of command line interfaces and plurality of local access modules.

In further another embodiment, a head-end for a cable modem system is disclosed. The head-end includes an input, a cache and an output. The input is adapted to receive configuration requests from one or more user interfaces. The cache is adapted to store configuration data of select subscriber modems in a user interface friendly format and the output is adapted to output the configuration data in the cache.

### BRIEF DESCRIPTION OF THE DRAWINGS

The present invention can be more easily understood and further advantages and uses thereof more readily apparent, when considered in view of the description of the preferred embodiments and the following figures in which:

FIG. 1 is a simplified block diagram of a communication system of one embodiment of the present invention;

FIG. 2 is an illustration of another communication system of another embodiment of the present invention; and

FIG. 3 is a sequencing chart illustrating one method of one embodiment of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description of the present embodiments, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that logical, electrical or mechanical changes may be made without departing from the scope of the present invention. The following detailed description is, therefore, not to be taken in a limiting sense, and the scope of the present invention is defined only by the appended claims and equivalents thereof.

Embodiments of the present invention provide a mechanism to handle large quantity data retrieval. In one embodiment, a requesting entity sends a data file request directly to a data source (such as a head-end, local access module or the like). Once the data source receives the message, the data source dumps the desired configuration data into a data file in a user interface friendly format. The data source then sends the data file to a user interface of the requesting entity. In another embodiment, a grouping mechanism is used to group the same data file requests from multiple user interface entities. Once grouped, only a single request is sent to the data source and the data file received in response to the data source request is shared between the user interface entities. The messaging approach of the embodiments of the present invention dispatch requests to data sources much faster than interface software of a SNMP mechanism. Moreover, the data source can efficiently package and transport the data. In addition, since data is already packaged in a user interface friendly format, said data can be displayed faster and more efficiently. The embodiment that groups the data file requests saves system resources for entities which host the data sources.

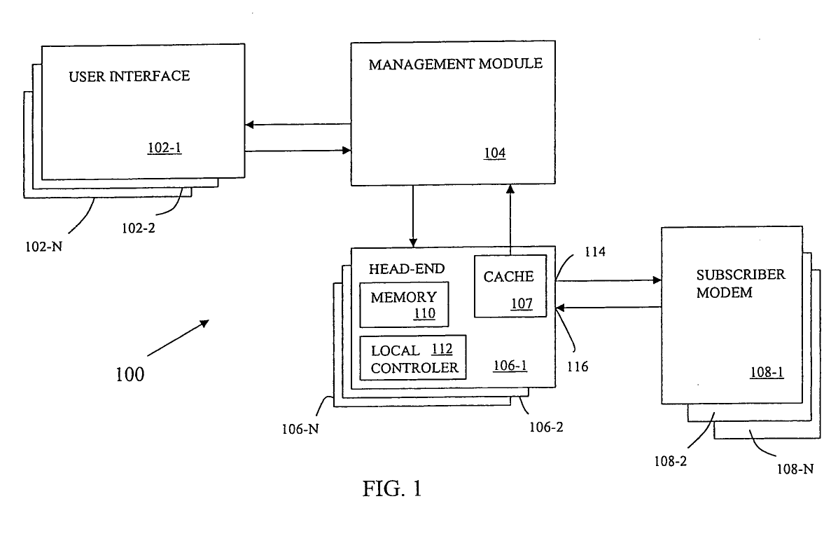

Referring to FIG. 1, a simplified block diagram of a communication system of one embodiment of the present invention is illustrated. As illustrated, the communication system includes user interfaces 102(1-N), a management module 104, head-ends 106(1-N) and subscriber modems 108(1-N). In one embodiment, the head-ends 106(1-N) are local access modules. Moreover, in one embodiment, switched socket messaging mechanism is used between the management module 104 and the head ends 106(1-N) to send the request directly to a selected head-end 106(1-N) where the data is stored. A local controller 112 in the select head-end 106(1-N) caches and maintains user interface friendly data. In one embodiment, when a configuration request is received by a head-end 106(1-N), the local controller 112 retrieves the configuration data from the select modem 108(1-N) via ports 114 and 116. The local controller then stores the configuration data in an interface friendly format in the cache 107. The local controller 112 then quickly transfers the data in the cache 107 to the management module 104. In one embodiment, the local controller 112 uses interface transfer protocol (TFTP) in transferring the data in the cache 107 to the management module 104. The data is then passed on to the user interface 102(1-N) which made the configuration request. The user interface 102(1-N) which requested the configuration data parses and displays the data to a user.

As stated above, the data format stored in the cache of a head-end is user interface friendly. In one embodiment, the data is stored in a host order (p6 processor). For example, Table 1 illustrates user friendly bytes used in one embodiment of the present invention. Moreover, in one embodiment, a cache 107 also includes a header that indicates the version of information and the modem count. En example of header information is illustrated in Table 2.

TABLE 1

| COMMON | BYTES |
|---|---|
| Mac Address | 6 bytes, network order |
| IP Address | 4 bytes, network order |
| SHOW MODEM | |
| SID | 2 bytes, unsigned integer |
| CID | 1 byte, unsigned integer |
| CPE count | 1 byte, unsigned integer |
| Down Stream | |
| Up Stream | 1, byte, unsigned integer, DS in upper |
| | nibble, US lower |
| Power | 4 bytes, float |
| Timing | 4 bytes, signed integer |
| State | 1 byte, unsigned integer |
| SHOW MODEM STATS | |
| Pkts | 4 bytes, unsigned long int. |
| NonErr | 4 bytes, unsigned long int. |
| CorrErr | 4 bytes, unsigned long integer |
| UnCorr | 4 bytes, unsigned long integer |

TABLE 2

| HEADER | BYTES |
|---|---|
| Version | 1 byte, unsigned integer |
| Modem Count | 2 bytes, unsigned integer |
| Request ID | 1 byte, unsigned integer |

In one embodiment of the present invention, cache 107 only stores the modem information upon receiving a request from one or more user interfaces 102(1-N). Since this embodiment of the present invention limits the simultaneous user interface requests to only one request at a time, the head-end 106 only has to process one request at a time. Therefore, a large amount of memory 110 in the head-end 106 does not have to be allocated for this process. The single request requirement, the limited amount of memory used in this process and use of user friendly interface data produces a relatively fast method of obtaining configuration data. In addition, in one embodiment, the head-end 106 allocates memory based on modem numbers in the network instead of a fixed number (such as, 3000 maximum modem number per cable modem termination system).

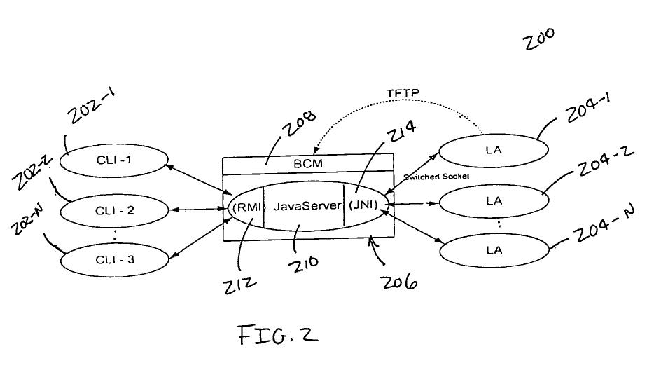

FIG. 2 illustrates another embodiment of the present invention. As illustrated, this embodiment includes a plurality of command line interfaces CLIs 202(1-N), a management module 206 and a plurality of local access modules (LAs) 204(1-N). Each LA 204(1-N) can be referred to as a cable modem termination system CMTS head-end or more generally as a head-end 204(1-N). The CLIs(1-N) in this embodiment can be referred to as user interfaces 202(1-N). The Management module 206 of this embodiment includes a JAVA server 210, a JAVA remote method invocation (RMI) 212 and a JAVA native interface (JNI) 214. The RMI 212 enables communication of JAVA technology-based to JAVA technology-based applications. The JNI 214 is a standard interface for writing JAVA native methods. The management module 206 also includes a bas cluster manager (BCM) 208.

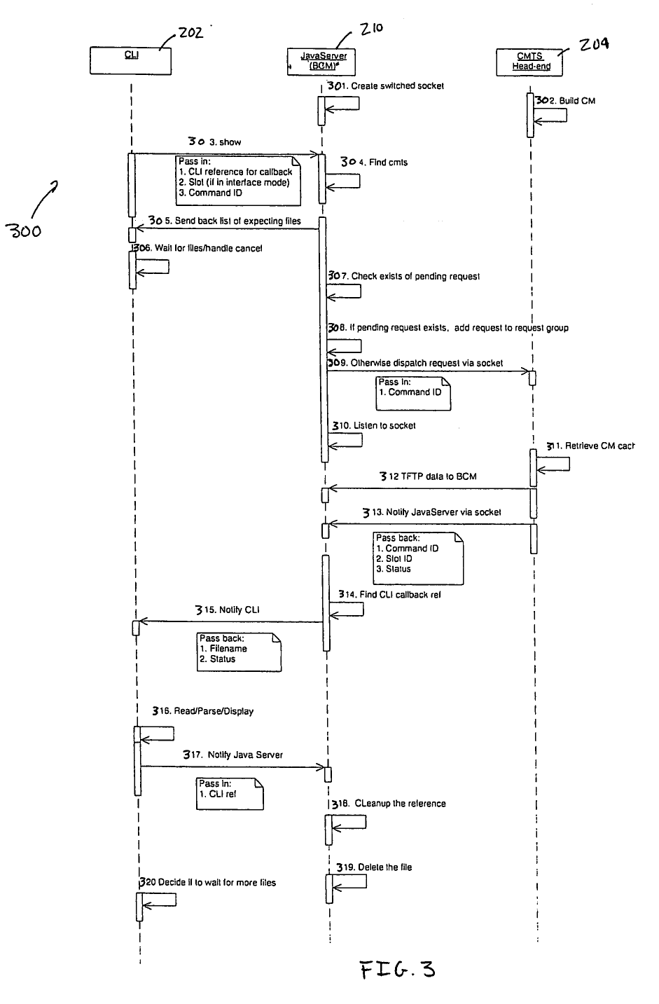

The messaging mechanism of the embodiment of FIG. 2 synchronizes three participating parties, the CLIs 202(1-N) the JAVA server 210 in the management module 206 and a select head-end 204(1-N). As illustrated, interactions between the CLIs 202(1-N) and JAVA Server 210 uses the RMI mechanism 212. Moreover, the interaction between the JAVA server 210 and the CMTS head-ends 204(1-N) use switched socket and TFTP for data transfer. For example, the interactions between the three components, a select user interface 202(1-N), the JAVA server 210 and a select head end 204(1-N) are shown in the sequencing chart 300 of FIG. 3.

Referring to FIG. 3, when the JAVA server 210 starts, it creates a switched socket in the JNI 214 (301). The switched socket will dispatch messages to the select CMTS head-end 204(1-N) and receive messages from the select CMTS head-end 204(1-N). Upon starting, the select CMTS head-end 204(1-N) builds a cable modem cache and keeps the caches in sync whenever related cable modem attributes get updated (302). A select CLI 202(1-N) sends command ID to a specific CMTS head-end 204(1-N) if the command is issued in interface mode. The select CLI 202(1-N) also sends a CLI remote reference object for the JAVA server 210 to call back once the file is ready (303). After JAVA server 210 receives the request, if no specific CMTS head-end 204(1-N) is available, the JAVA server 210 searches all CMTS modules 204(1-N) based on its cached topology information (304). The JAVA server 210 returns a list of data files names to the select CLI 202(1-N), which correspond to the CMTS modules 204(1-N) (305). The select CLI 202(1-N) waits to be notified by the JAVA server 210 when the actual files are ready (306). In addition, the user in this embodiment has the ability to cancel a pending request at this stage. The JAVA server 210 receives the CLI requests and checks if a request has already been dispatched to the select CMTS head-end 20(1-N) (307). If there is a dispatched request, the JAVA server 210 adds the CLI callback reference as an additional receipt of a previously sent request (308). This reduces the workload of the select CMTS head-end 204 (204-1) if there are multiple clients (multiple CLIs 202(1-N)) sending the same request within a short time interval (308).

If there is no dispatched request, the JAVA server 210 will send a request to the select CMTS head-end 204(1-N) (309). The JAVA server 210 listens to the switched socket for notification packets from the select head-end 204(1-N) (310). Once the select head-end 204(1-N) receives the request, the head-end 204(1-N) retrieves the data in an associated cable modem cache. The select head-end 204(1-N) transfers the cable modem data from the associated cable modem cache via TFTP to the BCM 208 (312). The select head-end 204(1-N) notifies the JAVA server 210 of the retrieval results via switch socket (313). The notification comes with command ID, head-end 204(1-N) ID and status data. The JAVA server 210 then correlates the notification to all interested CLI 202(1-N) call back references (314). The JAVA server 210 also sends notification to the waiting select CLI clients 202(1-N) via CLI's callback reference object (315). The respective CLI 202(1-N) reads, parses and displays the file (316). The select CLI 202(1-N) notifies the JAVA sever 210 that parsing is done or the command is canceled by the user (317). The JAVA server 210 then cleans up the CLI reference (318). If there is no more CLI callback reference objects waiting to consume the file, the java server 210 deletes the file (319). Finally, the select CLI 202(1-N) checks its list of expecting files, if all the files are back, the select CLI 202(1-N) completes the command operation. Otherwise, if not all the files are back the select CLI 202(1-N) goes back to step (306) to wait for the rest of the files. (320).

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any such adaptations or variations of the invention. It is manifestly intended that this invention be limited only by the following claims and equivalents thereof.

1. A method of communicating between electronic devices, the method comprising;
initiating a request for configuration data from a user interface;
sending the configuration request to a data source;
placing the configuration data into a data file in a user interface friendly format at the data source; and
sending the data file to the user interface.

2. The method of claim 1, further comprising:
receiving the data file at the user interface;
parsing the configuration data; and
displaying the configuration data.

3. The method of claim 1, further comprising:
grouping configuration requests from two or more user interfaces to a data source; and
sharing the received data file from the data source among the two or more user interfaces.

4. The method of claim 1, wherein sending the configuration data request to the data source further comprises:
using a switched socket connection.

5. The method of claim 1, wherein sending the data file to the user interface, further comprises:
using a trivial interface transfer protocol.

6. The method of claim 1, further comprising:
storing the configuration data in a data file in a cache in the data source upon receiving the configuration data request.

7. The method of claim 1, further comprising:
including a header in the data file.

8. The method of claim 7, wherein the header includes the version of information and a count of the number of records of configuration data being transferred.

9. A method of retrieving a large amount of configuration data in a telecommunication system having one or more command line interfaces, a management module and one or more head-ends, the method comprising:
generating a configuration request from one of the command line interfaces;
receiving the configuration request in an associated local access module;
outputting configuration data in a data file that is in a command line interface friendly format to a management module; and
passing the data file to the command line interface that requested the configuration data.

10. The method of claim 9, further comprising:
storing the configuration data in a cache of the local access module upon receiving the configuration request.

11. The method of claim 9, wherein outputting the configuration data further comprises:
using a trivial transfer interface protocol.

12. The method of claim 9, further comprising:
parsing the data file with the command line interface; and
displaying the data.

13. The method of claim 9, further comprising:
using a switched socket connection to send the configuration request to the local access module.

14. The method of claim 9, further comprising:
grouping configuration data requests from multiple command line interfaces to a local access module; and
sharing the response to the request between the multiple command line interfaces.

15. The method of claim 14, wherein the grouping of configuration requests further comprises:
grouping configuration requests occurring within a relatively short time interval.

16. The method of claim 14, wherein grouping of configuration requests further comprises:
checking if a request has already been sent to the local access module; and
when a request has already been sent, providing command line interfaces with additional requests, the data file from the local access module.

17. A communication system comprising:
a plurality of command line interfaces;
a plurality of local access modules adapted to provide configuration data to select command line interface in a command line interface friendly format; and
a management module adapted to dispatch interface configuration data between the plurality of command line interfaces and plurality of local access modules.

18. The communication system of claim 17, wherein the management module is adapted to create a switch socket connection to dispatch and receive messages between the management module and the plurality of local access modules.

19. The communication system of claim 17, wherein the plurality of local access modules are adapted to use trivial interface transfer protocol when transferring configuration data to the management module.

20. The communication system of claim 17, wherein the management module further comprises:
a bas cluster manager adapted to receiving the configuration data; and
a server adapted to control communication functions between the plurality of control line interfaces and the plurality of local access modules.

21. The communication system of claim 17, wherein each of the plurality of local access modules includes a cache adapted to contain configuration data in an associated command line interface friendly format.

22. The communication system of claim 17, wherein the management module is adapted to group configuration data requests from two or more command line interfaces to a select local access module in a single request.

23. The communication system of claim 17, wherein upon receiving the requested configuration data at a command line interface, the command line interface is adapted to read, parse and display the configuration data.

24. The communication system of claim 17, wherein each local access module is adapted to be coupled to at least one subscriber modem.

25. A head-end for a cable modem system, the head-end comprising:
an input adapted to receive configuration requests from one or more user interfaces;
a cache adapted to store configuration data of select subscriber modems in a user interface friendly format; and
an output adapted to output the configuration data in the cache.

26. The head-end of claim 25, wherein the output is adapted to trivial file transfer protocol.

27. The head-end of claim 25, wherein the cache stores the configuration data upon receiving the configuration request.

28. The head-end of claim 25, further comprising:
one or more ports adapted to be coupled to one or more subscriber cable modems.

29. The head-end of claim 25, further comprising:
a memory; and
a local controller, the local controller adapted to store the configuration data in the cache upon receiving the configuration request.

30. The head-end of claim 25, wherein the cache is further adapted to store a header.
